(19) United States
(12) Patent Application Publication
(10) Pub. No.: US 2021/0340935 A1
(43) Pub. Date: Nov. 4, 2021

(54) EGR EJECTOR SYSTEM

(71) Applicant: EATON INTELLIGENT POWER LIMITED, Dublin (IE)

(72) Inventors: James MCCARTHY, Kalamazoo, MI (US); Aseem DESAI, Bavdhan (IN); Sagar CHAVAN, Wagholi (IN)

(21) Appl. No.: 17/261,697

(22) PCT Filed: Jul. 19, 2019
(86) PCT No.: PCT/EP2019/069527

§ 371 Date: Jan. 20, 2021

Related U.S. Application Data
(60) Provisional application No. 62/735,395, filed on Sep. 24, 2018.

(30) Foreign Application Priority Data
Jul. 20, 2018 (IN) 201811027153

(51) Int. Cl. F02M 26/19; F02M 26/04; F02M 26/14; F02M 26/12

(52) U.S. Cl. CPC F02M 26/19; F02M 26/12; F02M 26/14; F02M 26/04

(57) ABSTRACT

An exhaust gas recirculation ejector system for an engine that includes an air conduit coupled to an engine providing charge air to the engine. The air conduit includes at least one bend formed therein. The at least one bend includes a port formed therein. An EGR conduit is coupled to an exhaust manifold of the engine at a first end of the EGR conduit. A second end of the EGR conduit passes through the port and extends into the air conduit at the bend defining an ejector mixing the charge air and exhaust gas before entry into the engine.

### FIELD OF THE INVENTION

The invention relates to exhaust gas recirculation (EGR) ejectors and a system for EGR.

### BACKGROUND OF THE INVENTION

There are many previously known automotive vehicles that utilize internal combustion engines such as diesel, gas or two stroke engines to propel the vehicle. In some constructions EGR (exhaust gas recirculation) recirculates the exhaust gas into the engine for mixture with the cylinder charge. The EGR that is intermixed with the air and fuel to the engine enhances the overall combustion of the fuel. This, in turn, reduces exhaust gas emissions.

Various prior art systems may use an EGR valve and a standard venturi to measure EGR to an intake manifold. However, such systems typically operate at undesired pressures and result in a loss of fuel economy. There is therefore a need in the art for an improved EGR system that operates over various engine operating conditions.

### SUMMARY OF THE INVENTION

In one aspect, there is disclosed an exhaust gas recirculation ejector system for an engine that includes an air conduit coupled to an engine providing charge air to the engine. The air conduit includes at least one bend formed therein. The at least one bend includes a port formed therein. An EGR conduit is coupled to an exhaust manifold of the engine at a first end of the EGR conduit. A second end of the EGR conduit passes through the port and extends into the air conduit at the bend defining an ejector mixing the charge air and exhaust gas before entry into the engine.

In another aspect there is disclosed, an exhaust gas recirculation ejector system for an engine that includes an air conduit coupled to an engine providing charge air to the engine. The air conduit includes at least one bend formed therein. The at least one bend includes a port formed therein. An EGR conduit is coupled to an exhaust manifold of the engine at a first end of the EGR conduit. A second end of the EGR conduit passes through the port and extends into the air conduit at the bend a terminal point of the second end of the EGR conduit is spaced from the inner diameter D1 in an amount of from 5 to 15 mm defining an ejector mixing the charge air and exhaust gas before entry into the engine.

In a further aspect there is disclosed, an exhaust gas recirculation ejector system for an engine that includes an air conduit coupled to an engine providing charge air to the engine. The air conduit includes at least one bend formed therein. The at least one bend includes a port formed therein. An EGR conduit is coupled to an exhaust manifold of the engine at a first end of the EGR conduit. A second end of the EGR conduit passes through the port and extends into the air conduit at the bend wherein the charge air includes an outlet flow path and the second end of the EGR conduit passes through the port and includes an inlet flow path and wherein an angle A defined by an angle between the outlet flow path and the inlet flow path is from 2 to 20 degrees.

### BRIEF DESCRIPTION OF THE DRA GS

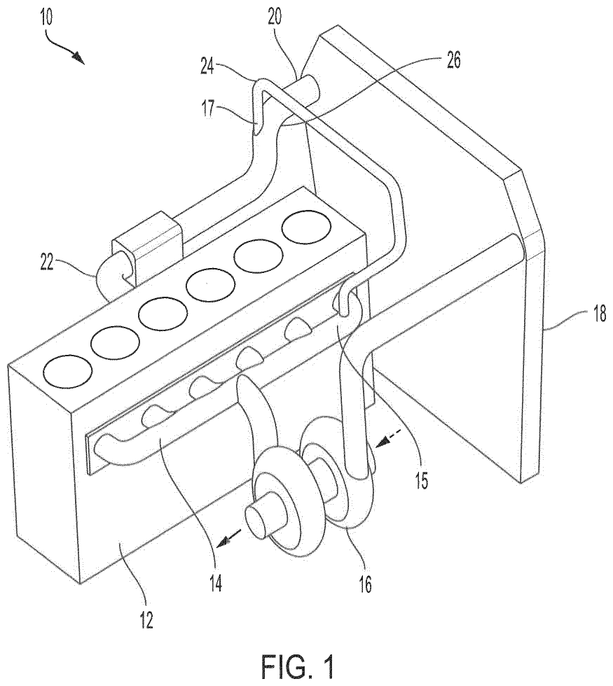

FIG. 1 is a perspective view of the EGR system including a 6 cylinder diesel engine including a turbocharger and charge air cooler;

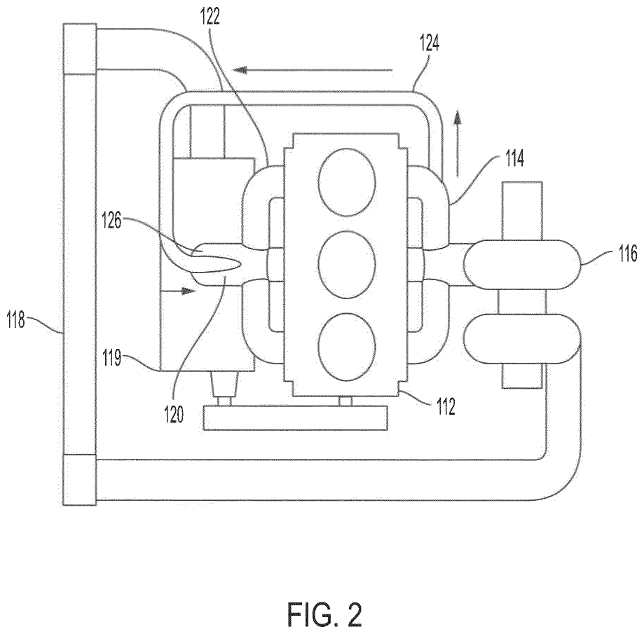

FIG. 2 is a perspective view of the EGR system including a 3 cylinder opposed piston engine including a turbocharger, supercharger and charge air cooler;

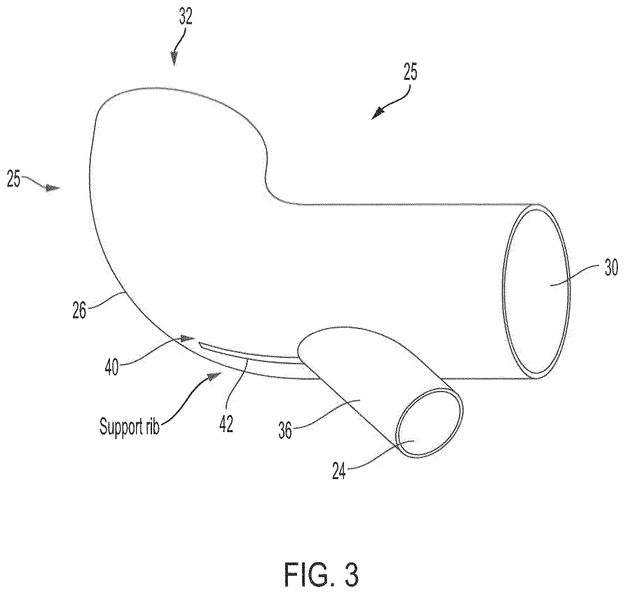

FIG. 3 is a perspective view of the EGR ejector;

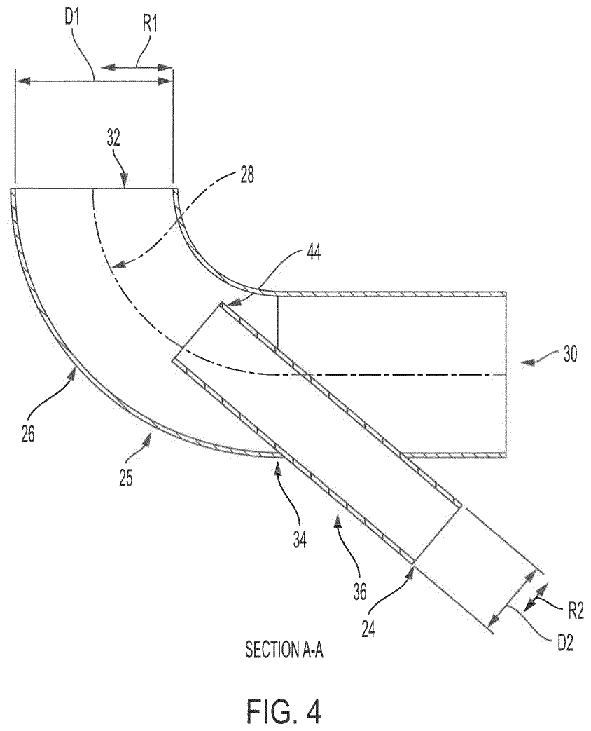

FIG. 4 is a sectional view of the EGR ejector;

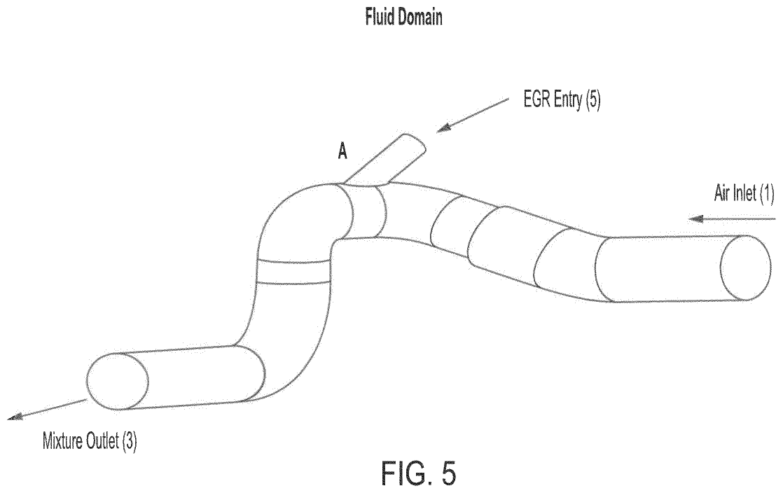

FIG. 5 is a partial perspective view of an intake pipe for an engine including an ejector in a pipe for an EGR system,

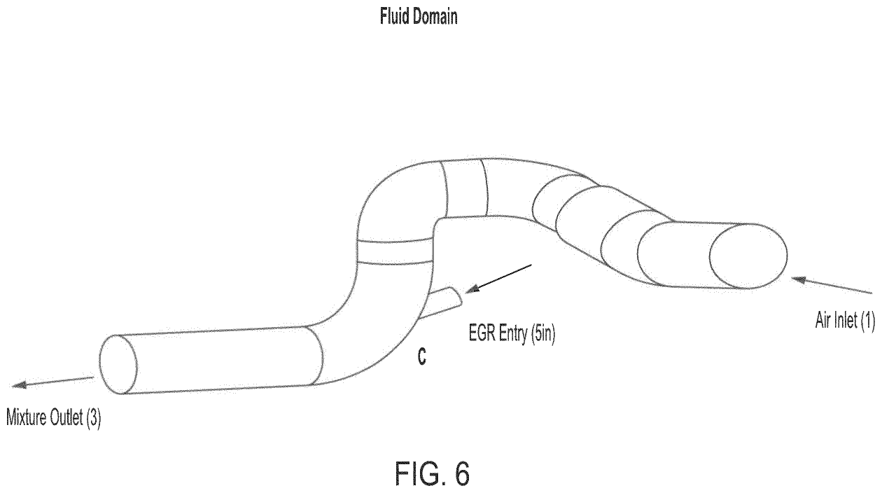

FIG. 6 is a partial perspective view of an intake pipe for an engine including an ejector in a pipe for an EGR system,

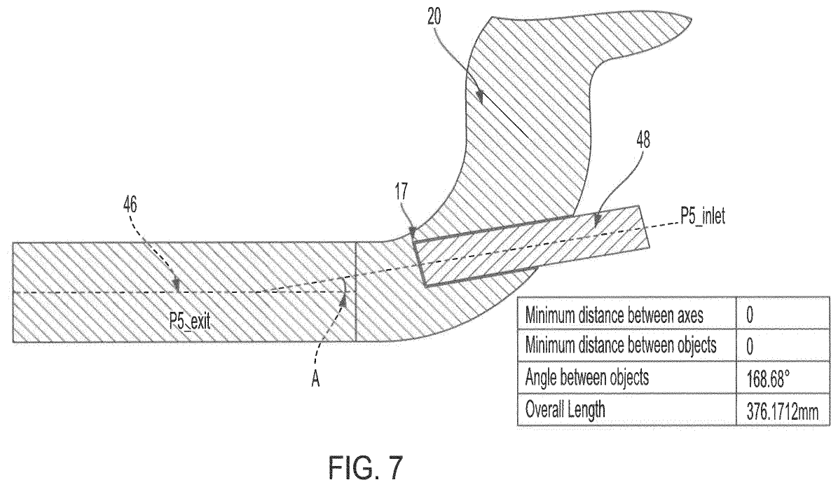

FIG. 7 is a partial sectional view of an intake pipe for an engine including an ejector in a pipe for an EGR system showing an angle A,

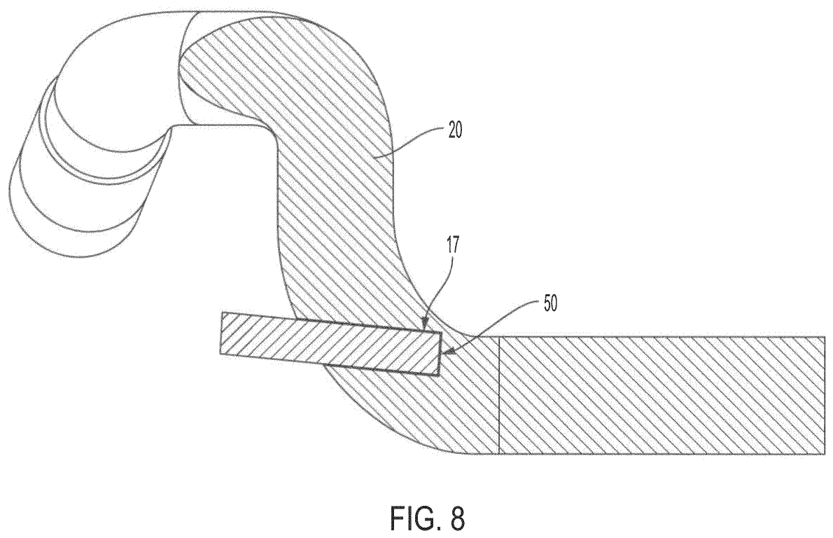

FIG. 8 is a sectional view of the EGR ejector including a 0 degree angled terminal face;

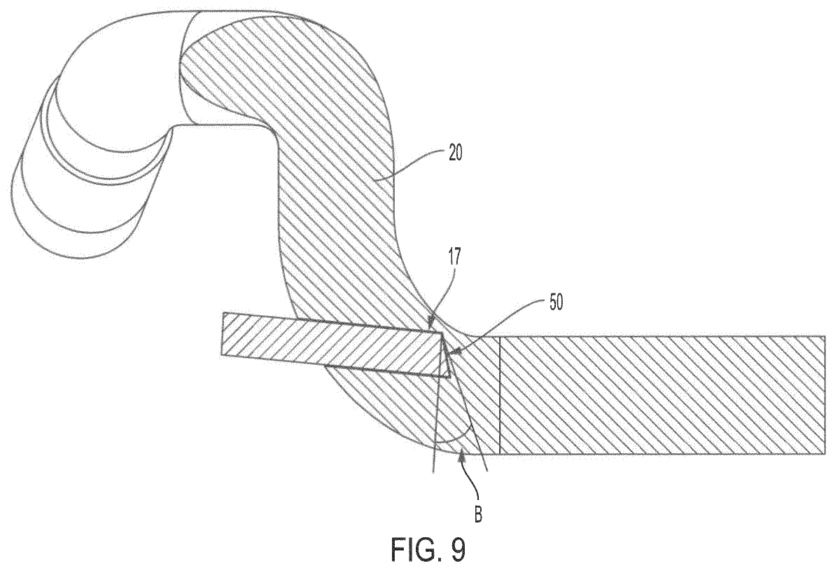

FIG. 9 is a sectional view of the EGR ejector including a 15 degree angled terminal face;

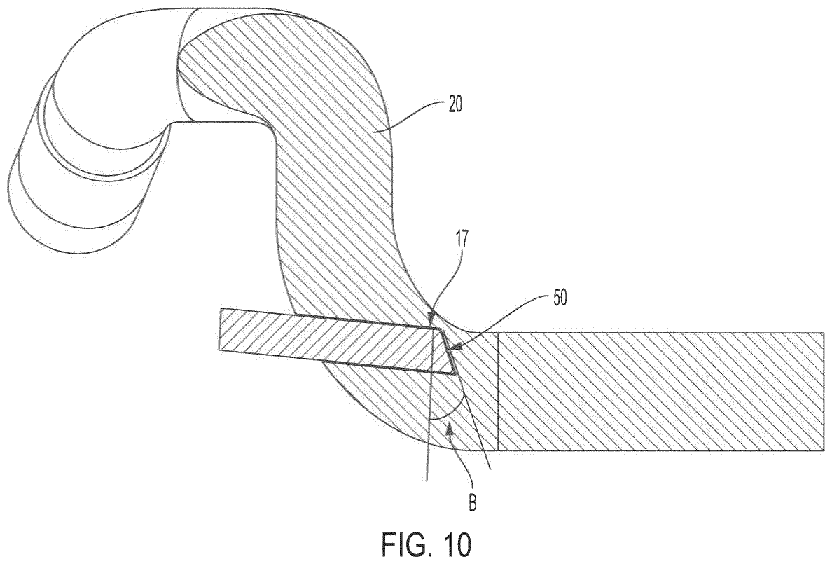

FIG. 10 is a sectional view of the EGR ejector including a 25 degree angled terminal face;

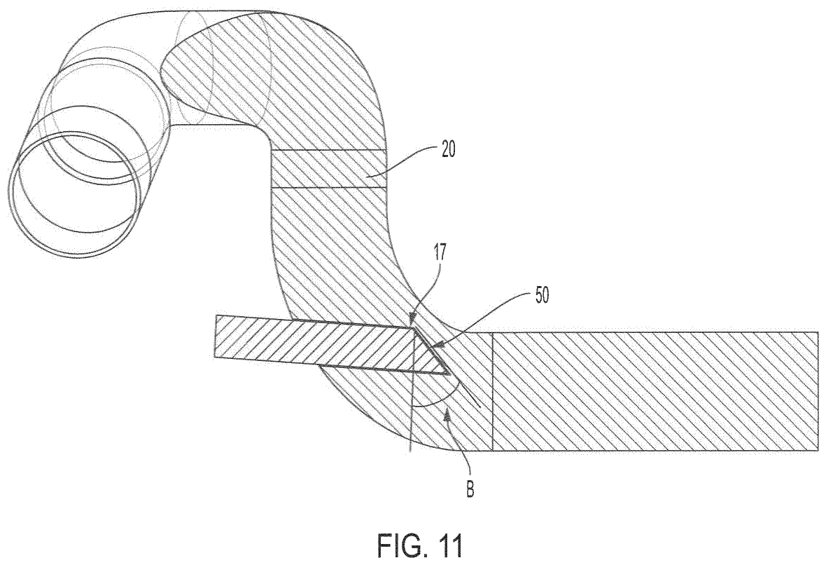

FIG. 11 is a sectional view of the EGR ejector including a 45 degree angled to face.

### DETAILED DESCRIPTION OF THE PREFERRED EMBODIMENTS

Referring to FIG. 1, there is shown one Exhaust Gas Recirculation (EGR) system 10 for a six cylinder diesel engine 12. The system includes an exhaust manifold 14 coupled to the engine 12. A turbocharger 16 is connected to the exhaust manifold 14 and to a charge air cooler 18. The charge air cooler 18 is connected to an air conduit 20 that provides air to an intake manifold 22 of the engine 12. An EGR conduit 24 is connected to the exhaust manifold 14 at a first end 15 before or upstream of the turbocharger 16 such that there is an increased flow of exhaust gases as opposed to a connection after the turbocharger 16.

The EGR conduit 24 may be coupled to additional components including an EGR cooler, pressure sensor and EGR control valve (not shown). The EGR conduit 24 is connected at the second end 17 to the air conduit 20. In one aspect, the EGR conduit is connected at a bend 26 of the air conduit 20 to define an ejector or injector 25 for the EGR gases into the air conduit 20 to define a mixing device that mixes charge air and exhaust gases for EGR.

Referring to FIG. 2, there is shown another Exhaust Gas Recirculation (EGR) system 110 for a three cylinder opposed piston engine 112. The system includes an exhaust manifold 114 coupled to the engine 12. A turbocharger 116 is connected to the exhaust manifold 114 and to a charge air cooler 118. The charge air cooler 118 is connected to a super charger 119 that includes an air conduit 120 that provides air to an intake manifold 122 of the engine 112. An EGR conduit 124 is connected to the exhaust manifold 114 at one end before or upstream of the turbocharger 116 such that there is an increased flow of exhaust gases as opposed to a connection after the turbocharger 116.

The EGR conduit 124 may be coupled to additional components including an EGR cooler, pressure sensor and EGR control valve (not shown). The EGR conduit 124 is connected at the opposing end to the air conduit 120. In one aspect, the EGR conduit 124 is connected at an elbow 126 of the air conduit 120 to define an ejector or injector for the EGR gases into the air conduit to define a mixing device.

Referring to FIGS. 3-4, the mixing device includes a mixing chamber 28 that is disposed in the charge air or inlet air conduit 20 to allow exhaust gas to mix with the inflowing charge air. The mixing chamber 28 is defined by the bend 26. The bend may span from 60 to 120 degrees. In the depicted embodiment, the bend is about 90 degrees. In one aspect, the bend 26 may be the last bend formed in the air conduit before entering an intake manifold 22 of the engine 12.

The mixing chamber 28 includes an inlet 30 for receiving charge air from a charge air source, including the turbocharger 16 and charge air cooler 18. The mixing chamber 28 also includes an outlet 32 to discharge charge air and exhaust gas. The mixing chamber 28 also includes a port 34 formed therein between the inlet 30 and the outlet 32 to siphon exhaust gas from the EGR conduit 24 into the mixing chamber 28.

A mixer tube 36 which is an end of the EGR conduit 24 passes through the port to extend into the bend 26 and mixing chamber 28.

The mixer tube 36 defines a venturi or ejector device. A venturi device reduces the pressure of a flowing gas by forcing the flow through a constriction. Within the constriction, the neck region of the venturi, the reduced pressure draws exhaust gases from the EGR conduit 24 into the air conduit 20. The air mixes with the exhaust increasing the exhaust oxygen content and reducing the exhaust temperature.

The pressure reduction of a Venturi follows from Bernoulli's principle. Bernoulli's principle states the pressure of a flow will decrease in relation to the flow speed. The decrease is roughly proportional to the density of the fluid multiplied by the flow speed squared. Typically, the venturi will be sized to provide a volume flow of EGR gases from the EGR conduit from 0 to 50%. With zero representing no EGR flow as controlled by a control valve. In one aspect, the EGR flow may be from 20 to 30% by volume based on the volume of the intake air.

In one aspect, as described above, the mixer tube 36 is integrated into the bend 26. A bend 26 is a portion of a conduit over which the direction of the channeled flow, averaged through complete cross-sections of the flow, changes. Within the bend 26, the momentum of the flow concentrates the intake air on the outer portion of the bend. By restricting the airflow to narrow toward the outer portion of the bend 26, the back pressure created by the bend 26 can be utilized as the back pressure for the venturi.

The turbulent flow on the outer portion of a pipe bend imparts flow acceleration. By Bernoulli's principle, the pressure in the outer portion of the bend will be reduced. Positioning the mixing tube 36 within the region of reduced pressure can provide a venturi even without a physical constriction of the flow. In one aspect, a constriction may be utilized to maintain the accelerated flow condition beyond the pipe bend.

Referring to FIG. 3, the bend 26 may include a slot 40 formed through the air conduit 20 and a rib 42 is formed on the second end of the EGR conduit 24. The rib 42 is positioned in the slot 40 positioning the second end 17 of the EGR conduit 24 relative to the air conduit and preventing movement of the second end 17 of the EGR conduit. The rib 42 may be welded or otherwise attached to the air conduit. 20

Referring to FIG. 4, the air conduit 20 includes an inner radius R1 and the EGR conduit includes an inner radius R2 and a ratio of R1/R2 is from 2.5 to 2.9. In one aspect, R2 is from 13-20 millimeters and in another aspect from 15-16 millimeters. In this manner, the pressure of the exhaust is lowered below the intake while also meeting desired EGR flowrates. Further, the back pressure of the air conduit is maintained within a desired limit such as 2400 Pa and the suction pressure is maintained negative to draw exhaust gas into the air conduit.

Referring to FIG. 4, the air conduit includes an inner diameter D1 and the EGR conduit includes an inner diameter D2 and wherein D2 is at 2.23 times smaller relative to D1. In this manner, the pressure of the exhaust is lowered below the intake while also meeting desired EGR flowrates. Further, the back pressure of the air conduit is maintained within a desired limit such as 2400 Pa and the suction pressure is maintained negative to draw exhaust gas into the air conduit.

Referring to FIG. 4, a terminal point 44 of the second end of the EGR conduit is spaced from the inner diameter D1 in an amount of from 5 to 15 mm. In this manner, the pressure of the exhaust is lowered below the intake while also meeting desired EGR flowrates. Further, the back pressure of the air conduit is maintained within a desired limit such as 2400 Pa and the suction pressure is maintained negative to draw exhaust gas into the air conduit.

Referring to FIGS. 5 and 6, the ejector 25 may be positioned in various bends 26 of the air conduit 20. The position of the ejector 25 in various bends 26 may alter the performance and pressures within the system as will be discussed in more detail below.

Referring to FIG. 7, the charge air includes an outlet flow path 46 and the second end 17 of the EGR conduit 24 passes through the port and includes an inlet flow path 48 and wherein an angle A defined by an angle between the outlet flow path 46 and the inlet flow path 48 is from 2 to 20 degrees. Adjusting the angle may influence, the suction or negative pressure produced and maintain such suction of a range of engine operating conditions.

Referring to FIGS. 8-11, a terminal end of the second end of the EGR conduit includes an angled face 50 formed thereon wherein the angled face includes an angle B measured relative to a horizontal plane defined by a top surface of the second end 17 of the EGR conduit 24 and wherein 0°≤B≤45°. Adjusting the angle of the face may influence, the suction or negative pressure produced.

### EXAMPLES

Computational Fluid dynamic calculations were performed to analyze various parameters of the ejector including the size of the diameter and radius of the EGR conduit and air conduit, the angle A defined by an angle between the outlet flow path and the inlet flow path, the angle B of the angled face at various engine operating conditions. The parameters shown in the Figures and as displayed in various tables which follow include: P1, the inlet pressure of the air charge, P3, the outlet pressure of the air charge, P5 in, the inlet pressure of the EGR gas, and P5 ext, the outlet pressure of the EGR gas.

Table 1 includes the pressure parameters of ejectors of various size at the positions shown in FIGS. 5 and 6 at a C100 operating condition. The ejector position of A and C are shown in FIGS. 5 and 6 respectively.

TABLE 1
C100 Operating Point

| | | CFD Results | | | |
|---|---|---|---|---|---|
| Ejector | Ejector | (Pressure in Kpa) | | | |
| Size (mm) | Position | P1-P3 | P5in-P3 | P5ext-P3 | P3 |
| 20 | A | 2.4 | 0.5 | −0.9 | 351 |
| 20 | C | 3.2 | −0.7 | −1.1 | 351 |
| 16 | C | 1.6 | −0.4 | −1.25 | 351 |
| 13 | A | 1.5 | 0.05 | −1.5 | 351 |
| Baseline Prior | | 2.4 | 0.05 | 0.3 | 351 |
| art EGR | | | | | |

As can be seen from the data in the table, the size and position of the ejector has an effect on the generation of a negative pressure or suction to move EGR gas into the charge air stream. The ejector at position C having a 16 mm radius produced the greatest negative pressure −0.4 KPa while maintaining a difference between the inlet and outlet pressures of the air charge less than 2.4 KPa.

Table 2 includes the pressure parameters of ejectors of various size at position C and having various angles A at a C100 operating condition. The angle A is shown in FIG. 7.

TABLE 2

| | | P5 in | P1 |
|---|---|---|---|
| | | EGR inlet | Air inlet |
| Diameter | Angle | Pressure | Pressure |
| (mm) | (degrees) | (Pa) | (Pa) |
| 16 | 10 | −550 | 2000 |
| 16 | 20 | −400 | 1600 |
| 16 | 30 | −500 | 1900 |
| 18 | 20 | −550 | 2050 |
| 18 | 30 | −450 | 2250 |
| 20 | 10 | −650 | 3100 |
| 20 | 20 | −700 | 3200 |
| 20 | 30 | −550 | 2750 |

As can be seen from the data in the table 2, the size and angle A of the ejector has an effect on the generation of a negative pressure or suction to move EGR gas into the charge air stream. The ejector at position C having a 16 mm radius at 10 degrees angle and a 18 mm radius at 20 degrees angle produced the greatest negative pressure −550 Pa while maintaining a difference between the inlet and outlet pressures of the air charge less than 2.4 KPa.

Table 3 includes the pressure parameters of ejectors having a 16 mm radius size at position C having various angles B. The angle B is shown in FIGS. 8-11.

TABLE 3
C100 Operating Point

| | CFD Results | |
|---|---|---|
| Ejector Mouth | (Pressure in Kpa) | |
| Cut Angle | P1-P3 | P5in-P3 |
| 0 | 2.34 | −0.61 |
| 15 | 2.35 | −0.71 |
| 25 | 2.32 | −0.75 |
| 45 | 2.3 | −0.8 |

As can be seen from the data in the table 3, the angle B of the ejector has an effect on the generation of a negative pressure or suction to move EGR gas into the charge air stream. The ejector having a 45 degree angle produced the greatest negative pressure −0.8 KPa while maintaining a difference between the inlet and outlet pressures of the air charge less than 2.4 KPa.

Table 4 includes the pressure parameters of an ejector at position C having a 16 mm radius Angle A of 5 degrees and angle B of 45 degrees at various engine operating conditions.

Position C, 16 mm radius, angle A of 5 degrees and facecut angle B of 45 degrees

| Operating Point | P1-P3 | P5in-P3 | P5ext-P3 | P3 | P5in | P5ext | P1 |
|---|---|---|---|---|---|---|---|
| C100 | 2.3 | −0.81 | −1.55 | 201.81 | 201 | 200.26 | 204.11 |
| C75 | 1.62 | −0.59 | −1.25 | 171.97 | 171.38 | 170.72 | 173.59 |
| Ref (185 KW) | 0.96 | −0.27 | −0.52 | 156.87 | 156.6 | 156.35 | 157.83 |
| A50 | 0.6 | −0.16 | −0.32 | 99 | 98.84 | 98.68 | 99.6 |
| A25 | 0.2 | −0.04 | −0.1 | 21.25 | 21.21 | 21.15 | 21.45 |

As can be seen from the data in the table 4, the ejector at position C, having a 16 mm radius, Angle A of 5 degrees and angle B of 45 degrees produced a negative pressure (P5in−P3) over all of the engine conditions while maintaining a difference between the inlet and outlet pressures of the air charge less than 2.4 KPa.

In use, a portion of the exhaust gases are routed from the exhaust manifold 14 by the EGR conduit 24. The direction of flow is indicated by the arrows in FIG. 1. The compressor for the turbocharger 16 provides the flow of the air through the charge air cooler 18 and air conduit 20 to draw or siphon exhaust gas from the EGR conduit 24 into the air conduit 20 for routing to the intake manifold 22 of the engine 12.

The EGR system including the ejector is a passive system without moving parts and is soot and temperature resistant. The system provides a compact packaging integrated into the bend. The system will work with conventional turbochargers (FGT) or VGT turbochargers. The ejector design will provide the maximum EGR flow and an EGR control valve may be utilized to lessen the flow of EGR gases.

1. An exhaust gas recirculation ejector system for an engine comprising:
an air conduit coupled to an engine providing charge air to the engine, the air conduit including at least one bend formed therein, the at least one bend including a port formed therein;
an EGR conduit coupled to an exhaust manifold of the engine at a first end of the EGR conduit;
a second end of the EGR conduit passing through the port and extending into the air conduit at the bend defining an ejector mixing the charge air and exhaust gas before entry into the engine.

2. The exhaust gas recirculation ejector system of claim 1 wherein the bend spans from 60 to 120 degrees.

3. The exhaust gas recirculation ejector system of claim 2 wherein the bend spans 90 degrees.

4. The exhaust gas recirculation ejector system of claim 2 wherein the bend spans 90 degrees and is the last bend before an inlet manifold of the engine.

5. The exhaust gas recirculation ejector system of claim 1 wherein the air conduit includes an inner radius R1 and the EGR conduit includes an inner radius R2 and a ratio of is from 2.5 to 2.9.

6. The exhaust gas recirculation ejector system of claim 5 wherein R2 is from 13-20 millimeters.

7. The exhaust gas recirculation ejector system of claim 5 wherein R2 is from 15-16 millimeters.

8. The exhaust gas recirculation ejector system of claim 1 wherein the air conduit includes an inner diameter D1 and the EGR conduit includes an inner diameter D2 and wherein D2 is at 2.23 times smaller relative to D1.

9. The exhaust gas recirculation ejector system of claim 1 wherein the charge air includes an outlet flow path and the second end of the EGR conduit passes through the port and includes an inlet flow path and wherein an angle A defined by an angle between the outlet flow path and the inlet flow path is from 2 to 20 degrees.

10. The exhaust gas recirculation ejector system of claim 1 wherein a terminal point of the second end of the EGR conduit is spaced from the inner diameter D1 in an amount of from 5 to 15 mm.

11. The exhaust gas recirculation ejector system of claim 1 further including a slot formed through the air conduit and a rib formed on the second end of the EGR conduit, the rib positioned in the slot positioning the second end of the EGR conduit relative to the air conduit and preventing movement of the second end of the EGR conduit.

12. The exhaust gas recirculation ejector system of claim 1 wherein a terminal end of the second end of the EGR conduit includes an angled face formed thereon wherein the angled face includes an angle B measured relative to a horizontal plane defined by a top surface of the second end of the EGR conduit and wherein 0°≤B≤45°.

13. An exhaust gas recirculation ejector system for an engine comprising:
an air conduit coupled to an engine providing charge air to the engine, the air conduit including at least one bend formed therein, the at least one bend including a port formed therein;
an EGR conduit coupled to an exhaust manifold of the engine at a first end of the EGR conduit;
a second end of the EGR conduit passing through the port and extending into the air conduit at the bend wherein a terminal point of the second end of the EGR conduit is spaced from the inner diameter D1 in an amount of from 5 to 15 mm defining an ejector mixing the charge air and exhaust gas before entry into the engine.

14. The exhaust gas recirculation ejector system of claim 13 wherein the air conduit includes an inner radius R1 and the EGR conduit includes an inner radius R2 and a ratio of R1/R2 is from 2.5 to 2.9.

15. The exhaust gas recirculation ejector system of claim 13 wherein the air conduit includes an inner diameter D1 and the EGR conduit includes an inner diameter D2 and wherein D2 is at 2.23 times smaller relative to D1.

16. The exhaust gas recirculation ejector system of claim 13 wherein the charge air includes an outlet flow path and the second end of the EGR conduit passes through the port and includes an inlet flow path and wherein an angle A defined by an angle between the outlet flow path and the inlet flow path is from 2 to 20 degrees.

17. The exhaust gas recirculation ejector system of claim 13 further including a slot formed through the air conduit and a rib formed on the second end of the EGR conduit, the rib positioned in the slot positioning the second end of the EGR conduit relative to the air conduit and preventing movement of the second end of the EGR conduit.

18. The exhaust gas recirculation ejector system of claim 13 wherein a terminal end of the second end of the EGR conduit includes an angled face formed thereon wherein the angled face includes an angle B measured relative to a horizontal plane defined by a top surface of the second end of the EGR conduit and wherein 0°≤B≤45°.

19. An exhaust gas recirculation ejector system for an engine comprising:
an air conduit coupled to an engine providing charge air to the engine, the air conduit including at least one bend formed therein, the at least one bend including a port formed therein;
an EGR conduit coupled to an exhaust manifold of the engine at a first end of the EGR conduit;
a second end of the EGR conduit passing through the port and extending into the air conduit at the bend wherein the charge air includes an outlet flow path and the second end of the EGR conduit passes through the port and includes an inlet flow path and wherein an angle A defined by an angle between the outlet flow path and the inlet flow path is from 5 to 20 degrees defining an ejector mixing the charge air and exhaust gas before entry into the engine.
